(19) United States
(12) Patent Application Publication
(10) Pub. No.: US 2015/0060202 A1
(43) Pub. Date: Mar. 5, 2015

(54) HANDRAIL ASSEMBLY FOR A TRAILER

(71) Applicant: Vince Fanello, Lavonia, GA (US)

(72) Inventor: Vince Fanello, Lavonia, GA (US)

(21) Appl. No.: 14/473,084

(22) Filed: Aug. 29, 2014

Related U.S. Application Data
(60) Provisional application No. 61/871,930, filed on Aug. 30, 2013.

(51) Int. Cl. B60R 3/00

(52) U.S. Cl. CPC B60R 3/005
USPC 182/113

(57) ABSTRACT

A handrail assembly for use with a trailer, including a platform having a first edge and a second edge, the platform extending outwardly therefrom from the first edge to the second edge secured to a side of the trailer, a handrail pivotably secured to the platform by a plurality of elongated members, and a piston secured to the platform at a first end and one of the elongated members at a second end. The piston is configured to move the handrail from a first position in which the plurality of elongated members are vertical, and a second position in which the plurality of elongated members are angled with respect to the platform.

### CLAIM OF PRIORITY

This application claims priority to U.S. Provisional Patent Application No. 61/871,930, filed Aug. 30, 2013, the entire disclosure of which is incorporated by reference herein.

### FIELD OF THE INVENTION

The present disclosure relates generally to handrails. More particularly, the present disclosure is related to a collapsible handrail for use with a trailer.

### BACKGROUND OF THE INVENTION

For various types of trailers, feed trailers, tank trailers, etc., it is often necessary for someone to climb on the trailer to assist in loading, unloading, inspecting cargo, etc. From a safety standpoint, these activities can lead to the person performing these tasks to reach fairly large heights and, therefore, be presented with increased opportunities for falls and subsequent injury. As well, various regulatory agencies, such as the Occupational Safety and Health Administration (OSHA), provide regulations dictating workplace safety standards for such operations. As such, it is desirable to provide safety features that help prevent injuries to those working on the trailer, as well as bring the trailer into conformity with regulatory standards.

The present invention recognizes and addresses considerations of prior art constructions and methods.

### SUMMARY

One embodiment of a handrail assembly in accordance with the present disclosure includes a handrail assembly for use with a trailer, having a platform having a first edge and a second edge, the platform extending outwardly therefrom from the first edge to the second edge secured to a side of the trailer, a handrail pivotably secured to the platform by a plurality of elongated members, and a piston secured to the platform at a first end and one of the elongated members at a second end. The piston is configured to move the handrail from a first position in which the plurality of elongated members are vertical, and a second position in which the plurality of elongated members are angled with respect to the platform.

Yet another embodiment includes a truck having a trailer, a handrail assembly including a platform having a first edge and a second edge, the first edge being secured adjacent the trailer and the platform extending outwardly therefrom to the second edge, a handrail pivotably secured to the platform by a plurality of elongated members, and a piston secured to the platform at a first end and one of the elongated members at a second end. The piston is configured to move the handrail from a first position in which the plurality of elongated members are vertical, and a second position in which the plurality of elongated members are angled with respect to the platform.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a perspective view of the truck including a handrail assembly in accordance with an embodiment of the present disclosure;

FIG. 2 is a perspective view of the handrail assembly shown in FIG. 1;

FIGS. 3A-3C are side elevational views of the handrail assembly, as shown in FIG. 1, being moved from the in-use position to the storage position; and

FIGS. 4A and 4B are side perspective views of the handrail assembly and trailer portion of the truck shown in FIG. 1.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

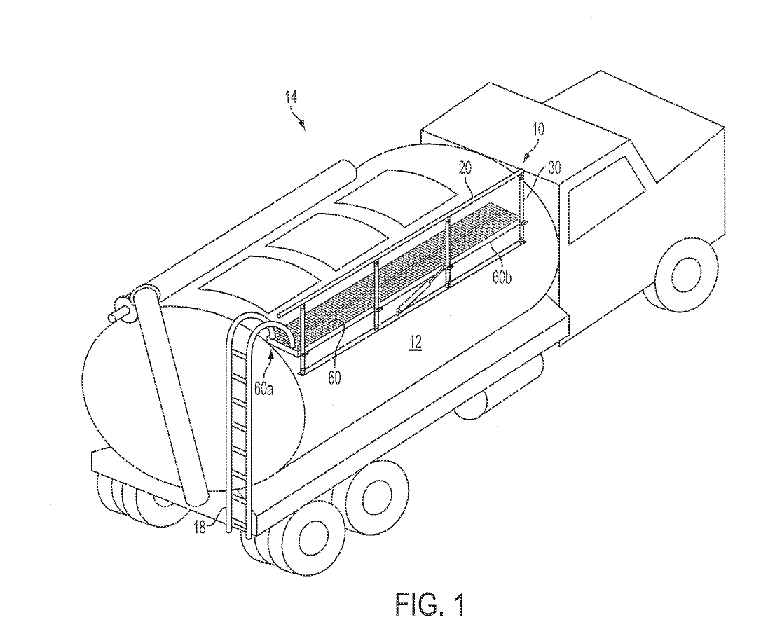

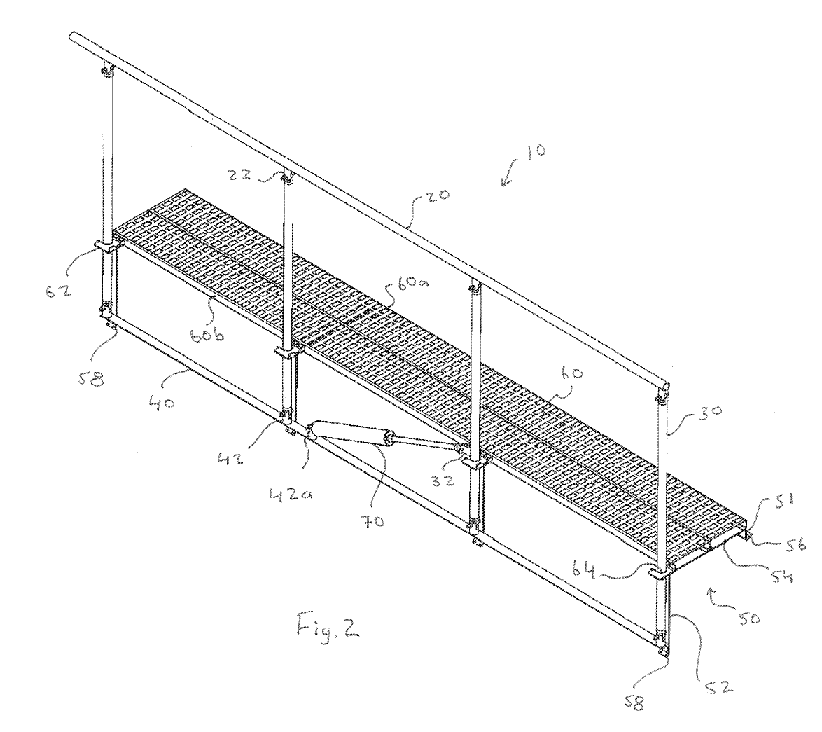

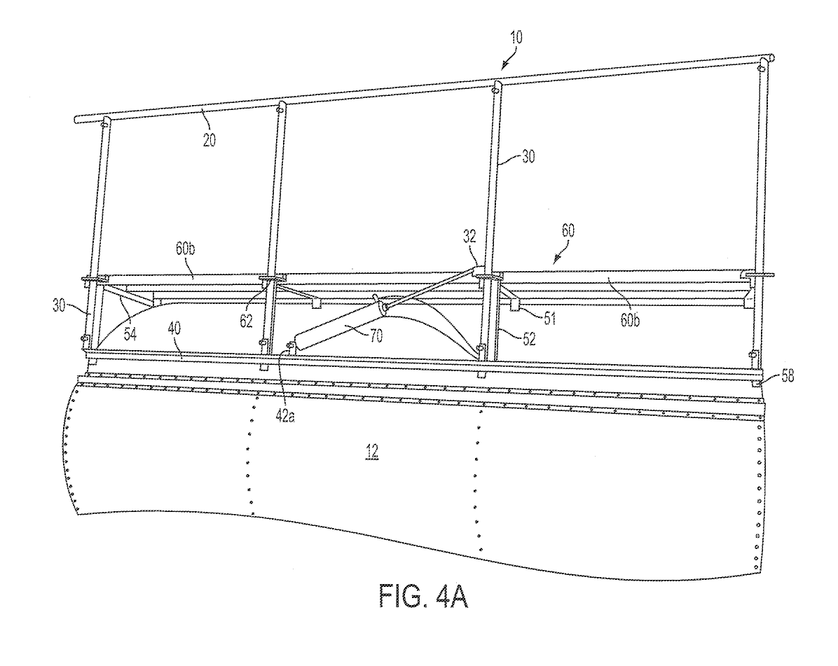

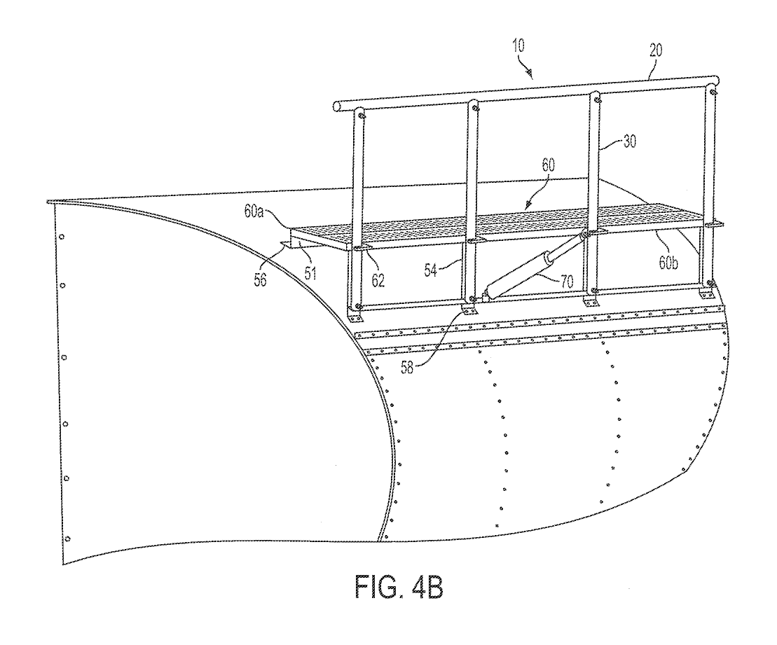

Referring now to the figures, FIG. 1 shows a trailer handrail assembly 10, in accordance with the present disclosure, mounted on a trailer 12 of a truck 14. Each handrail assembly 10 includes a handrail 20 that is pivotably mounted to a platform 60, the platform being mounted to the side of trailer 12 at its first edge 60a and extending horizontally outward therefrom to its second edge 60b, as best seen in FIGS. 4A and 4B. As shown, handrail 20 is secured to platform 60 by a plurality of elongated members 30, each elongated member 30 being pivotably attached at its top end to an anchor point 22 of handrail 20, and at its bottom end to an anchor point 42 of a horizontal member 40 (FIG. 2). A ladder 18 is preferably provided at the back end of truck 14 to allow an individual to access platform 60.

As best seen in FIGS. 2A and 4B, a plurality of angle brackets 50 are used to mount platform 60 to the side of trailer 12. Each angle bracket includes a horizontal portion 54 that directly supports platform 60, a first vertical portion 51 and a second vertical portion 52. As shown, each first vertical portion 51 and each second vertical portion 52 extends downwardly from first edge 60a and second edge 60b of platform 10, respectively. A distal end 56 and 58 of each first vertical portion 51 and each second vertical portion 52, respectively, is configured to conform to the portion of the trailer 12 to which platform 60 is attached. Specifically, each distal end 56 and 58 is angled with respect to the corresponding vertical portion of each bracket 50 to take into account the curved sidewall of trailer 12 to which handrail assembly 10 is attached. Additionally, due to the curvature of the sidewall of trailer 12, each second vertical portion 51 is shorter than each second vertical portion of each bracket 50. As best seen in FIG. 1, horizontal support 40 is attached to each angle bracket at the distal end 56 of its vertical portion 56 to provide rigidity to the structure.

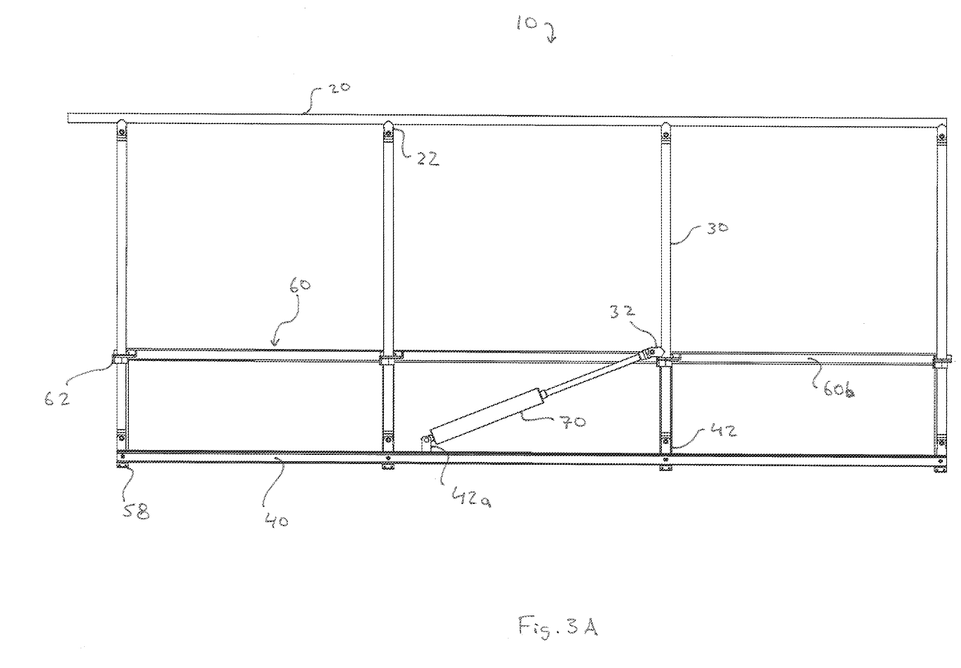

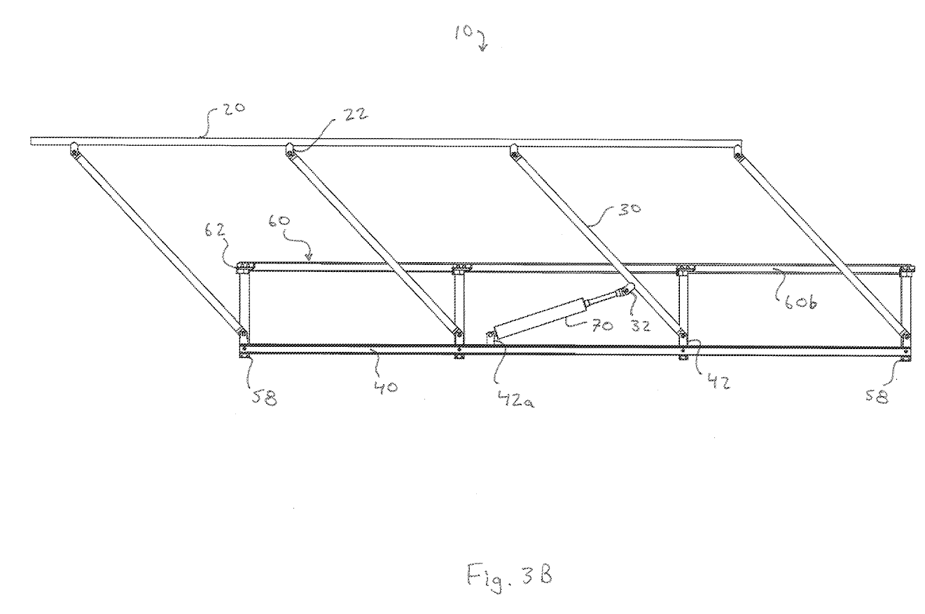

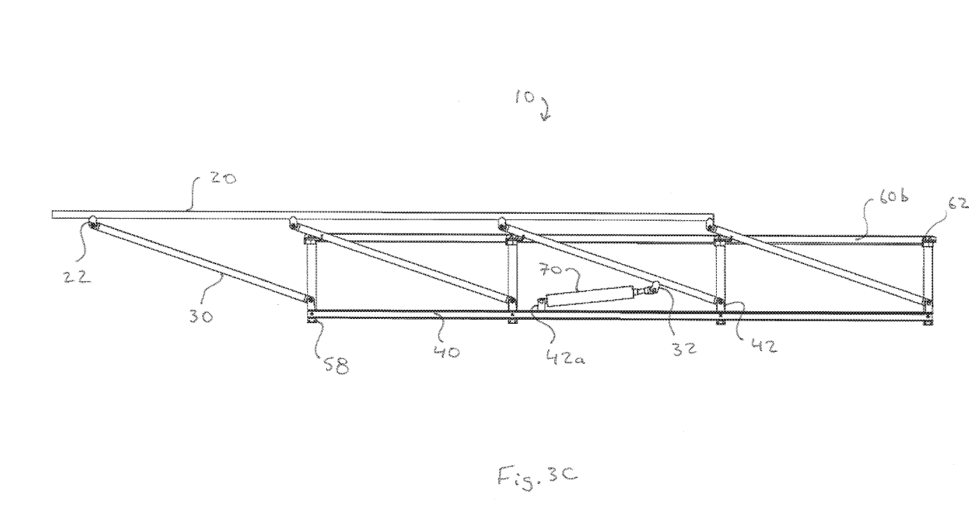

Preferably, a piston 70 is used to move handrail 20 from its stored position, as shown in FIG. 3C, to its in-use position, as shown in FIGS. 2 and 3A, and vice versa. One end of piston 70 is attached to an anchor point 32 disposed on a corresponding one of elongated members 30, and the other end of piston 70 is attached to an anchor point 42a of horizontal member 40. When piston 70 expands to the elongated position, as shown in FIGS. 2 and 3A, the elongation of piston 70 urges handrail 20 into the vertical, in-use position. Conversely, when piston 70 is retracted, as shown in FIG. 3C, handrail 20 returns to its stored position. Preferably, piston 70 is hydraulically operated. However, in alternate embodiments, piston 70 may be pneumatically operated as well, or omitted altogether.

As best seen in FIGS. 2 and 3A, when in use, handrail 20 is positioned so that elongated members 30 are vertically oriented, with each elongated member 30 being received in a recess 64 of a corresponding stop 62 that depends outwardly from distal edge 60b of platform 60. Preferably, each recess 64 is correspondingly shaped to the cross-section of the elongated member 30 that is seated therein. For example, in the present embodiment, each elongated member 30 has a circular cross-section and each recess 64 is substantially U-shaped with a semi-circular base wall, as best seen in FIG. 2. Note, however, in alternate embodiments, vertical members 30 may have square cross-sections and recesses 64 of stops 62 may have correspondingly flat base walls. When not in use, handrail 20 is moved to a retracted position, as shown in FIG. 3C, in which each elongated member 30 is angled with respect to platform 60 and comes to rest on the side of the adjacent stop 62 opposite its recess 64, as shown in FIG. 3C.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

What is claimed:

1. A handrail assembly for use with a trailer, comprising:
a platform having a first edge and a second edge, the platform extending outwardly therefrom from the first edge to the second edge secured to a side of the trailer;
a handrail pivotably secured to the platform by a plurality of elongated members; and
a piston secured to the platform at a first end and one of the elongated members at a second end,
wherein the piston is configured to move the handrail from a first position in which the plurality of elongated members are vertical, and a second position in which the plurality of elongated members are angled with respect to the platform.

2. The handrail assembly of claim 1, further comprising a plurality of stops extending outwardly from the second edge of the platform, wherein each elongated member of the plurality of elongated members is received by a corresponding stop when the plurality of elongated members is in the first position.

3. The handrail assembly of claim 2, wherein each stop of the plurality of stops defines a recess, each of elongated member of the plurality of elongated members being received in a recess of a corresponding stop when the plurality of elongated members is in the first position.

4. The handrail assembly of claim 1, further comprising:
a horizontal member fixed to the platform so that the horizontal member is parallel too the second edge of the platform; and
a piston having a first pivotably secured to the horizontal member and a second end pivotably secured to one of the plurality of elongated members.

5. The handrail assembly of claim 1, wherein the handrail assembly is mounted to a curved sidewall of the trailer with the first edge of the platform being adjacent the curved sidewall and the second edge of the platform extending outwardly therefrom.

6. The handrail assembly of claim 5, wherein the first edge of the platform is a first vertical distance for the curved sidewall, the second edge of the platform is a second vertical distance from the curved sidewall, and the first vertical distance is less than the second vertical distance.

7. The handrail assembly of claim 1, further comprising:
a first bracket and a second bracket, each of the first and second brackets including a first vertical portion extending from the first edge of the platform to the trailer wall and a second vertical portion extending from the second edge of the platform to the trailer wall, wherein the second vertical portion of the first and second brackets are longer than the first vertical portion of the first and second brackets.

8. The handrail assembly of claim 7, further comprising:
a horizontal member fixed to the platform so that the horizontal member is parallel too the second edge of the platform; and
a piston having a first pivotably secured to the horizontal member and a second end pivotably secured to one of the plurality of elongated members.

9. A truck, comprising:
a trailer;
a handrail assembly comprising:
a platform having a first edge and a second edge, the first edge being secured adjacent the trailer and the platform extending outwardly therefrom to the second edge;
a handrail pivotably secured to the platform by a plurality of elongated members; and
a piston secured to the platform at a first end and one of the elongated members at a second end,
wherein the piston is configured to move the handrail from a first position in which the plurality of elongated members are vertical, and a second position in which the plurality of elongated members are angled with respect to the platform.

10. The truck of claim 9 further comprising a plurality of stops extending outwardly from the second edge of the platform, wherein each elongated member of the plurality of elongated members is received by a corresponding stop when the plurality of elongated members is in the first position.

11. The truck of claim 10, wherein each stop of the plurality of stops defines a recess, each of elongated member of the plurality of elongated members being received in a recess of a corresponding stop when the plurality of elongated members is in the first position.

12. The truck of claim 9, further comprising:
a horizontal member fixed to the platform so that the horizontal member is parallel too the second edge of the platform; and
a piston having a first pivotably secured to the horizontal member and a second end pivotably secured to one of the plurality of elongated members.

13. The truck of claim 9, wherein the handrail assembly is mounted to a curved sidewall of the trailer with the first edge of the platform being adjacent the curved sidewall and the second edge of the platform extending outwardly therefrom.

14. The truck of claim 13, wherein the first edge of the platform is a first vertical distance for the curved sidewall, the second edge of the platform is a second vertical distance from the curved sidewall, and the first vertical distance is less than the second vertical distance.

15. The truck of claim 9, further comprising:
a first bracket and a second bracket, each of the first and second brackets including a first vertical portion extending from the first edge of the platform to the trailer wall and a second vertical portion extending from the second edge of the platform to the trailer wall, wherein the second vertical portion of the first and second brackets are longer than the first vertical portion of the first and second brackets.

16. The truck of claim 15, further comprising:
a horizontal member fixed to the platform so that the horizontal member is parallel too the second edge of the platform; and
a piston having a first pivotably secured to the horizontal member and a second end pivotably secured to one of the plurality of elongated members.
